(19) United States
(12) Patent Application Publication
(10) Pub. No.: US 2023/0342668 A1
(43) Pub. Date: Oct. 26, 2023

(54) SYSTEMS AND METHODS FOR PROVIDING AUTOMATED DATA SCIENCE AS A SERVICE

(71) Applicant: JPMORGAN CHASE BANK, N.A., New York, NY (US)

(72) Inventor: Niraj CHAURASIA, Holbrook, NY (US)

(21) Appl. No.: 18/304,027

(22) Filed: Apr. 20, 2023

Related U.S. Application Data
(60) Provisional application No. 63/363,276, filed on Apr. 20, 2022.

(51) Int. Cl. G06N 20/00

(52) U.S. Cl. CPC G06N 20/00

(57) ABSTRACT

A method for providing data science as a service may include a computer program: receiving training data; receiving a type of machine learning engine to train; performing a high-level data analysis on the training data; returning a plurality of essential variables to perform prediction in order of importance; receiving a selection of one or more of the essential variables; training the machine learning engine with the training data using the type of machine learning engine to train and the selected one or more essential variables; receiving production data from one or more production systems; applying the production data to the trained machine learning engine; and outputting an output of the trained machine learning engine to the one or more production systems and/or a data consumer, wherein the one or more production systems and/or the data consumer is configured to consume the output of the trained machine learning engine.

### RELATED APPLICATIONS

This application claims priority to, and the benefit of, U.S. Provisional Patent Application Ser. No. 63/363,276, filed Apr. 20, 2022, the disclosure of which is hereby incorporated, by reference, in its entirety.

### BACKGROUND OF THE INVENTION

### 1. Field of the Invention

Embodiments generally relate to systems and methods for providing automated data science as a service.

### 2. Description of the Related Art

On any day within an organization, a number of applications collect and create millions of datasets. These datasets often require to undergo manual analysis, which affects an Information Technology team's ability to respond to an issue as it takes a long time to process a ticket. In addition, the processing can be inaccurate and involve a number of laborious, manual, repetitive steps.

### SUMMARY OF THE INVENTION

Systems and methods for providing automated data science as a service are disclosed. In one embodiment, a method for providing automated data science as a service may include: (1) receiving, by a Data Science as a Service (DSaaS) computer program, training data; (2) receiving, by the DSaaS computer program, a type of machine learning engine to train; (3) performing, by the DSaaS computer program, a high-level data analysis on the training data; (4) returning, by the DSaaS computer program, a plurality of essential variables to perform prediction in order of importance; (5) receiving, by the DSaaS computer program, a selection of one or more of the essential variables; (6) training, by the DSaaS computer program, the machine learning engine with the training data using the type of machine learning engine to train and the selected one or more essential variables; (7) receiving, by the DSaaS computer program, production data from one or more production systems; (8) applying, by the DSaaS computer program, the production data to the trained machine learning engine; and (9) outputting, by the DSaaS computer program, an output of the trained machine learning engine to the one or more production systems and/or a data consumer, wherein the one or more production systems and/or the data consumer is configured to consume the output of the trained machine learning engine.

In one embodiment, the method may also include returning, by the DSaaS computer program, insights into data types, distributions, frequencies, and classifications of the data.

In one embodiment, the method may also include identifying, by the DSaaS computer program, a subset of the training data to exclude.

In one embodiment, the type of machine learning engine may include a Naïve Bayes model, an XGBoost model, or a Logistic Regression model.

In one embodiment, the essential variables may be identified from the training data.

In one embodiment, the production data may be received in real time.

In one embodiment, the output data may be formatted in the same format as the production data.

In one embodiment, the production data and the output data may have a format selected from the group consisting of xls, xlsx, json, and csv.

According to another embodiment, a system may include a data owner electronic device; an electronic device executing a data science as a service (DSaaS) computer program and a data science engine; a production system; and a data consumer electronic device. The DSaaS computer program receives training data, receives a type of machine learning engine to train from the data owner electronic device, performs a high-level data analysis on the training data, returns a plurality of essential variables to perform prediction in order of importance, receives a selection of one or more of the essential variables, trains the machine learning engine with the training data using the type of machine learning engine to train and the selected one or more essential variables, receives production data from one or more production systems, applies the production data to the trained machine learning engine, and outputs an output of the trained machine learning engine to the one or more production systems and/or a data consumer, wherein the one or more production systems and/or the data consumer is configured to consume the output of the trained machine learning engine.

In one embodiment, the DSaaS computer program may return insights into data types, distributions, frequencies, and classifications of the data.

In one embodiment, the DSaaS computer program may identify a subset of the training data to exclude.

In one embodiment, the type of machine learning engine may include a Naïve Bayes model, an XGBoost model, or a Logistic Regression model.

In one embodiment, the essential variables may be identified from the training data.

In one embodiment, the output data may be formatted in the same format as the production data, and the production data and the output data may have a format selected from the group consisting of xls, xlsx, json, and csv.

According to another embodiment, a non-transitory computer readable storage medium, may include instructions stored thereon, which when read and executed by one or more computer processors, cause the one or more computer processors to perform steps comprising: receiving training data; receiving a type of machine learning engine to train; performing a high-level data analysis on the training data; returning a plurality of essential variables to perform prediction in order of importance; receiving a selection of one or more of the essential variables; training the machine learning engine with the training data using the type of machine learning engine to train and the selected one or more essential variables; receiving production data from one or more production systems; applying the production data to the trained machine learning engine; and outputting an output of the trained machine learning engine to the one or more production systems and/or a data consumer, wherein the one or more production systems and/or the data consumer is configured to consume the output of the trained machine learning engine.

In one embodiment, the non-transitory computer readable storage medium may also include instructions stored thereon, which when read and executed by one or more computer processors, cause the one or more computer processors to return insights into data types, distributions, frequencies, and classifications of the data.

In one embodiment, the non-transitory computer readable storage medium may also include instructions stored thereon, which when read and executed by one or more computer processors, cause the one or more computer processors to identify a subset of the training data to exclude.

In one embodiment, the type of machine learning engine may include a Naïve Bayes model, an XGBoost model, or a Logistic Regression model.

In one embodiment, the essential variables may be identified from the training data.

In one embodiment, the output data may be formatted in the same format as the production data, and the production data and the output data may have a format selected from the group consisting of xls, xlsx, json, and csv.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 illustrates a system for providing automated data science as a service according to one embodiment.

FIG. 2 depicts a method for providing automated data science as a service according to one embodiment.

FIG. 3 depicts an exemplary computing system for implementing aspects of the present disclosure.

### DETAILED DESCRIPTION OF PREFERRED EMBODIMENTS

Embodiments are directed to systems and methods for providing automated data science as a service.

Embodiments may build machine learning (ML) models based on uploaded data, and expose those ML models as an Application Programming Interface (API) that may be integrated into a production system for a real-time ML capabilities. An independent data science platform facilitates a user of the platform to leverage their data without having background in data science.

Embodiments may provide accurate regression information from any dataset regardless of the application, accurate prediction and impact assessments on their variables, may reduce time to analyze data and get predictions, may provide various options to use the trained model (e.g., Application Programming Interface (API), File upload, user interface, etc.), and may provide the ability to use any dataset as it is data agnostic.

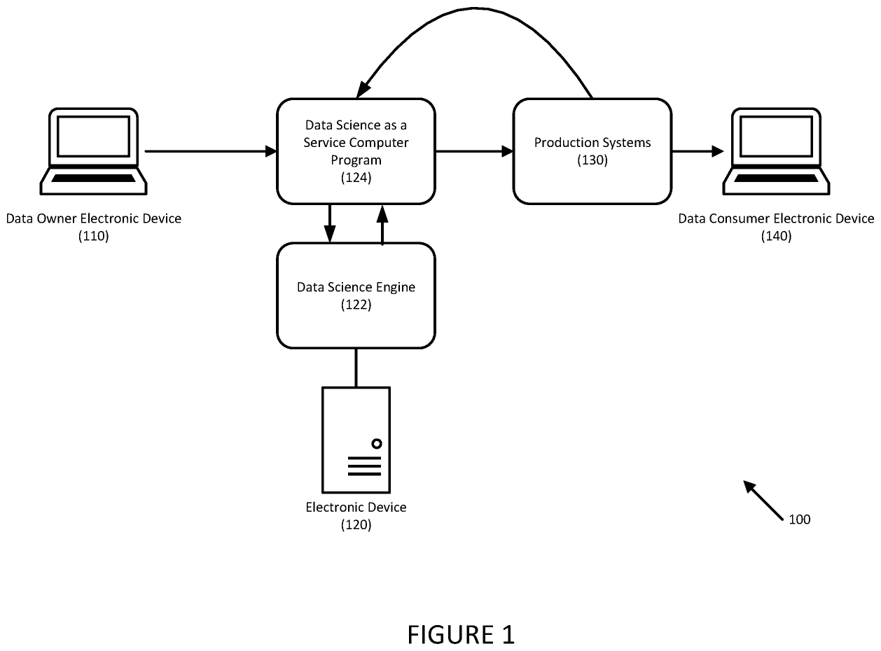

Referring to FIG. 1, a system for providing automated data science as a service is provided according to an embodiment. System 100 may include data owner electronic device 110, which may any suitable electronic device (e.g., computers, smart phones, etc.). Data owner electronic device 110 may interface with data science as a service computer program 124, which may be executed by electronic device 120. Electronic device may be, for example, a server (e.g., physical and/or cloud-based), a workstation, a desktop, laptop, notebook, or tablet computer, etc. Electronic device 120 may further execute data science engine 122, which may host one or more machine learning engines to be trained with data provided by data owner electronic device 110.

A data owner may select parameters for a machine learning engine that is to be trained. For example, the data owner may select, in a user interface provided by the data science as an engine computer program 124, the machine learning engine to be trained, including, for example, Classification and Regression models such as Naïve Bayes, XGBoost, Logistic Regression, etc.

System 100 may further include production systems 130, which may be any downstream system that may provide data to data science as a service computer program 124 to apply to a trained machine learning engine. Data science as a service computer program 124 may then provide the output from the trained machine learning engine to production systems 130 and then to data consumers using data consumer electronic device 140. In one embodiment, consumer electronic device 140 may receive the output of the trained machine learning engine from data science engine 122. The output may be provided in the format of the input data.

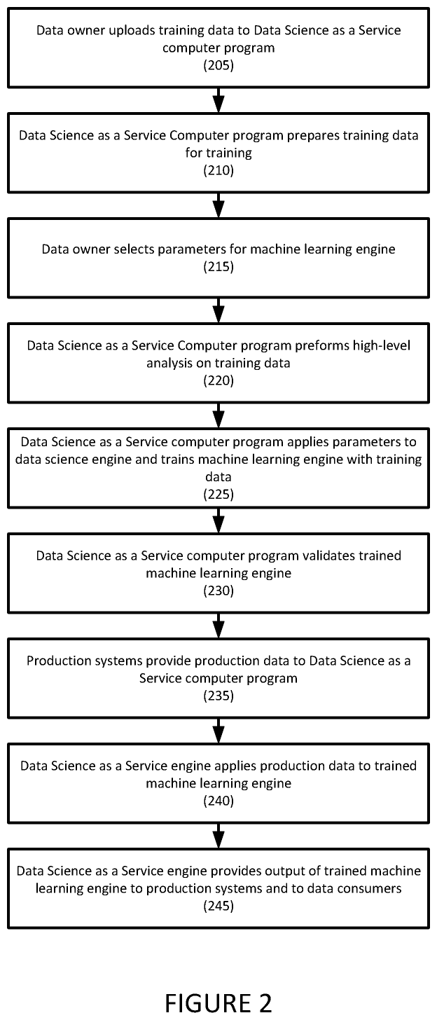

Referring to FIG. 2, a method for providing automated data science as a service is disclosed according to an embodiment.

In step 205, a data owner may upload training data to a Data Science as a Service computer program. In one embodiment, the training data may include historical training data. The training data may include a plurality of variables.

In one embodiment, the data owner may upload the training data in any standard format (e.g., xls, xlsx, json, csv).

In step 210, the data science as a service computer program may prepare the training data for training. For example, the data owner and/or the data science as a service computer program may exclude some parts of data from the training. For example, the data owner may exclude data that is not normal, includes null values, is highly skewed (e.g., due to outage or unresponsive services), etc.

In step 215, the data owner may select parameters for a machine learning engine. In one embodiment, the data owner may select a type of machine learning engine to train. Examples of machine learning engines may include Naïve Bayes model, an XGBoost model, a Logistic Regression models, etc.

In one embodiment, the data owner may also identify the variable out of the plurality of variables to predict.

In step 220, the data science as a service computer program may perform a high-level data analysis on the training data and may return insights into the data type, the distribution, the frequency and classifications. Examples of insights may include descriptive statistics; inferential statistics; mean, median, mode; dispersion, skewness; correlation coefficients; data size/frequency, etc. The data science as a service computer program may select the analysis that is best for the uploaded data type, and may return a list of essential variables to perform prediction in order of importance. The essential variables may be identified based on the uploaded data and data owners, users, etc. may select or deselect essential variables before training the machine learning.

For example, the essential variables may include the plurality of variables in the training data that are not being predicted. The data science as a service computer program may return the essential variables in ranked format to select/deselect one or more of the essential variables based on, for example, whether the essential variables are expected to be available in a real data feed.

In step 225, the data science as a service computer program may apply the parameters based on user input to a data science engine and may train the machine learning engine with the training data. For example, the data science as a service computer program may split the training data into train data and test data, and may train the machine learning engine with the train data. The machine learning engine may be classified into Classification and Regression models based on the parameters, such as Naïve Bayes, XGBoost, Logistic Regression, etc.

In step 230, once the machine learning engine is trained, the data science as a service computer program may validate the trained machine learning engine using the test data. For example, the data science as a service computer program may use the test data for the trained machine learning engine to generate predictions to check the accuracy of the trained machine learning engine. As the validation is based on test data that was not used for training at all and is unseen for the platform, it shows how the model will behave with real data when used.

In step 235, one or more production systems may provide production data to the data science as a service computer program. The production data may be provided in real time, or substantially in real time, and may be from any suitable system.

In one embodiment, the data science as a service computer program may expose an API that may be accessed by the production system(s).

In step 240, the data science as a service computer program may apply the production data to trained machine learning engine, and in step 245, the Data Science as a Service engine may provide the output of trained machine learning engine to the production system(s) and to data consumers. The data consumers may then consume the data.

For example, the output may be provided in any suitable format. For example, cleaned and pre-processed training data may be output in the form of the input format (e.g., xls, xlsx, json, csv) for other data science usage, variable ranking in the form of json or csv, trained model in the form of json or txt file, predicted data in the form of input format (e.g., xls, xlsx, json, csv), etc.

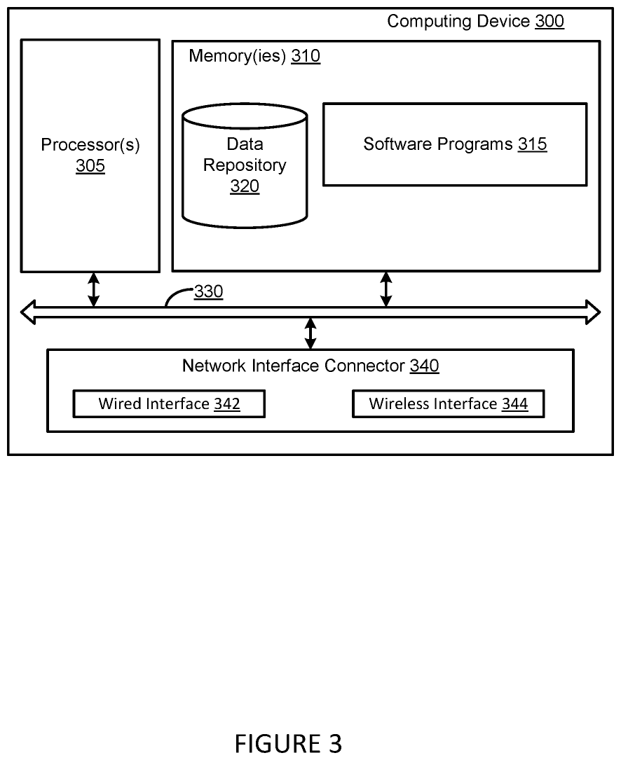

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while embodiments present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for providing automated data science as a service, comprising:
receiving, by a Data Science as a Service (DSaaS) computer program, training data;
receiving, by the DSaaS computer program, a type of machine learning engine to train;
performing, by the DSaaS computer program, a high-level data analysis on the training data;
returning, by the DSaaS computer program, a plurality of essential variables to perform prediction in order of importance;
receiving, by the DSaaS computer program, a selection of one or more of the essential variables;
training, by the DSaaS computer program, the machine learning engine with the training data using the type of machine learning engine to train and the selected one or more essential variables;
receiving, by the DSaaS computer program, production data from one or more production systems;
applying, by the DSaaS computer program, the production data to the trained machine learning engine; and
outputting, by the DSaaS computer program, an output of the trained machine learning engine to the one or more production systems and/or a data consumer, wherein the one or more production systems and/or the data consumer is configured to consume the output of the trained machine learning engine.

2. The method of claim 1, further comprising:
returning, by the DSaaS computer program, insights into data types, distributions, frequencies, and classifications of the data.

3. The method of claim 1, further comprising:
identifying, by the DSaaS computer program, a subset of the training data to exclude.

4. The method of claim 1, wherein the type of machine learning engine comprises a Naïve Bayes model, an XGBoost model, or a Logistic Regression model.

5. The method of claim 1, wherein the essential variables are identified from the training data.

6. The method of claim 1, wherein the production data is received in real time.

7. The method of claim 1, wherein the output data is formatted in the same format as the production data.

8. The method of claim 1, wherein the production data and the output data have a format selected from the group consisting of xls, xlsx, json, and csv.

9. A system, comprising:
a data owner electronic device;
an electronic device executing a data science as a service (DSaaS) computer program and a data science engine;
a production system; and
a data consumer electronic device;
wherein:
the DSaaS computer program receives training data;
the DSaaS computer program receives a type of machine learning engine to train from the data owner electronic device;
the DSaaS computer program performs a high-level data analysis on the training data;
the DSaaS computer program returns a plurality of essential variables to perform prediction in order of importance;
the DSaaS computer program receives a selection of one or more of the essential variables;
the DSaaS computer program trains the machine learning engine with the training data using the type of machine learning engine to train and the selected one or more essential variables;
the DSaaS computer program receives production data from one or more production systems;
the DSaaS computer program applies the production data to the trained machine learning engine; and
the DSaaS computer program outputs an output of the trained machine learning engine to the one or more production systems and/or a data consumer, wherein the one or more production systems and/or the data consumer is configured to consume the output of the trained machine learning engine.

10. The system of claim 9, wherein the DSaaS computer program returns insights into data types, distributions, frequencies, and classifications of the data.

11. The system of claim 9, wherein the DSaaS computer program identifies a subset of the training data to exclude.

12. The system of claim 9, wherein the type of machine learning engine comprises a Naïve Bayes model, an XGBoost model, or a Logistic Regression model.

13. The system of claim 9, wherein the essential variables are identified from the training data.

14. The system of claim 9, wherein the output data is formatted in the same format as the production data, and the production data and the output data have a format selected from the group consisting of xls, xlsx, json, and csv.

15. A non-transitory computer readable storage medium, including instructions stored thereon, which when read and executed by one or more computer processors, cause the one or more computer processors to perform steps comprising:
receiving training data;
receiving a type of machine learning engine to train;
performing a high-level data analysis on the training data;
returning a plurality of essential variables to perform prediction in order of importance;
receiving a selection of one or more of the essential variables;
training the machine learning engine with the training data using the type of machine learning engine to train and the selected one or more essential variables;
receiving production data from one or more production systems;
applying the production data to the trained machine learning engine; and
outputting an output of the trained machine learning engine to the one or more production systems and/or a data consumer, wherein the one or more production systems and/or the data consumer is configured to consume the output of the trained machine learning engine.

16. The non-transitory computer readable storage medium of claim 15, further including instructions stored thereon, which when read and executed by one or more computer processors, cause the one or more computer processors to return insights into data types, distributions, frequencies, and classifications of the data.

17. The non-transitory computer readable storage medium of claim 15, further including instructions stored thereon, which when read and executed by one or more computer processors, cause the one or more computer processors to identify a subset of the training data to exclude.

18. The non-transitory computer readable storage medium of claim 15, wherein the type of machine learning engine comprises a Naïve Bayes model, an XGBoost model, or a Logistic Regression model.

19. The non-transitory computer readable storage medium of claim 15, wherein the essential variables are identified from the training data.

20. The non-transitory computer readable storage medium of claim 15, wherein the output data is formatted in the same format as the production data, and the production data and the output data have a format selected from the group consisting of xls, xlsx, json, and csv.
